(19) United States
(12) Patent Application Publication
(10) Pub. No.: US 2017/0110899 A1
(43) Pub. Date: Apr. 20, 2017

(54) Galvanic Charging and Data Transfer of Remote Devices in a Personal Area Network System and Method

(71) Applicant: BRAGI GmbH, Munchen (DE)

(72) Inventor: Peter Vincent Boesen, Munchen (DE)

(21) Appl. No.: 15/290,629

(22) Filed: Oct. 11, 2016

Related U.S. Application Data
(60) Provisional application No. 62/244,158, filed on Oct. 20, 2015.

(51) Int. Cl. H02J 7/00; H04R 1/10

(52) U.S. Cl. CPC H02J 7/0052; H04R 1/1016; H04R 1/1025; H02J 2007/0096

(57) ABSTRACT

A method includes providing a first device, the first device having an electrode for placement at skin of a user, conveying power between the electrode of the first device and an electrode of a second device, wherein both the first device and the second device are associated with a personal area network and the second device is remote from the first device. The conveying power is performed through galvanic coupling.

### PRIORITY STATEMENT

This application claims priority to U.S. Provisional Patent Application 62/244,158, filed on Oct. 20, 2015, and entitled Galvanic Charging and Data Transfer of Remote Devices in a Personal Area Network System and Method, hereby incorporated by reference in its entirety.

### FIELD OF THE INVENTION

The present invention relates to personal area or wearable devices. More particularly, but not exclusively, the present invention relates to network communication for personal area devices.

### BACKGROUND

The construct of a Personal Area Network allows the user to link various wearable devices together in a meaningful way. However, to be effective as a wearable device, a device must incorporate function, durability, as well as a wearable form factor that will permit the user to tolerate it on the body for long periods of time. These constraints in and of themselves pose new problems which must be confronted in order to make the personal area network a tenable proposition for the user. Principal among these concerns is the ability to provide power to the wearable in a stable, functional fashion. When the requirement of the personal area network demands that the wearable device confirm to extremely small form factors (among a large number of potentially challenging variables) the power required to supply such form factors becomes a massive challenge. Therefore, what is needed is a new approach to creating a stable power supply for the new form factor wearable devices.

### SUMMARY

Therefore, it is a primary object, feature, or advantage of the present invention to improve over the state of the art.

It is a further object, feature, or advantage of the present invention to provide a new approach to creating a stable power supply for the new form factor wearable devices.

It is a still further object, feature, or advantage of the present invention to provide power to a remote wearable device in a Personal Area Network.

Another object, feature, or advantage is to provide power to an array of remote wearable devices in a Personal Area Network.

Yet another object, feature, or advantage is to provide a linkage among various devices with power supplies to provide power to the Personal Area Network.

A further object, feature, or advantage is to allocate power amongst the various power bearing devices in the Personal Area Network so that maximum levels of power can be obtained.

A still further object, feature, or advantage is to allocate power amongst the various power bearing devices in the Personal Area Network so that allocation can be based upon the available amount of power contained in the power containing devices.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an objects, features, or advantages stated herein.

According, to one aspect, a method includes providing a first device, the first device having an electrode for placement at skin of a user, conveying power between the electrode of the first device and an electrode of a second device, wherein both the first device and the second device are associated with a personal area network and the second device is remote from the first device. The conveying power is performed through galvanic coupling. The method may further include charging a battery of the second device using the power. The first and/or second devices may be wearable devices such as ear pieces. The power from the first device may be from a battery of the first device. The power from the first device may be generated by the first device such as being generated by converting motion associated with the user into charge. The method may further include conveying data between the first device and the second device through galvanic coupling. The electrode of the first device may be used both for conveying the power and conveying data.

According to another aspect, a method includes providing a first device, the first device having an electrode for placement at skin of a user and conveying data between the electrode of the first device and an electrode of a second device, wherein both the first device and the second device are associated with a personal area network and the second device is remote from the first device. The conveying data may be performed through galvanic coupling. At least one of the first device and the second device may be an ear piece.

### BRIEF DESCRIPTION OF THE DRAWINGS

FIG. 1 illustrates a first device and a second device connected through galvanic coupling.

FIG. 2 illustrates a device configured to receive power and/or data through galvanic coupling.

FIG. 3 illustrates a device configured to send power and/or data through galvanic coupling.

FIG. 4 illustrates one example of a set of wearable devices in the form of a left ear piece and a right ear piece.

### DETAILED DESCRIPTION

The present invention provides for the use of galvanic transmission of a personal area network to power the devices remote from the wearable device that is of a form factor large enough to provide the electromagnetic field which will power device. One such device is an earpiece wearable or bilateral earpiece wearable that takes advantage of a dual power supply as both a left ear piece and a right ear piece may each have its own power supply. This doubles the available power for the output of the electromagnetic fields, and may be used to provide more power at a single timeframe, or alternatively provide for twice the length of time. This allows for the ability of the devices to provide power to an array of devices over time, as well as to potentially allocate available power resources among devices based on their available power source as well as level of charge.

The present invention contemplates that the human body may be used as a transmission media for communicating electrical signals between different devices including wearable devices. The electrical signals may be data signals or may be signals to convey power.

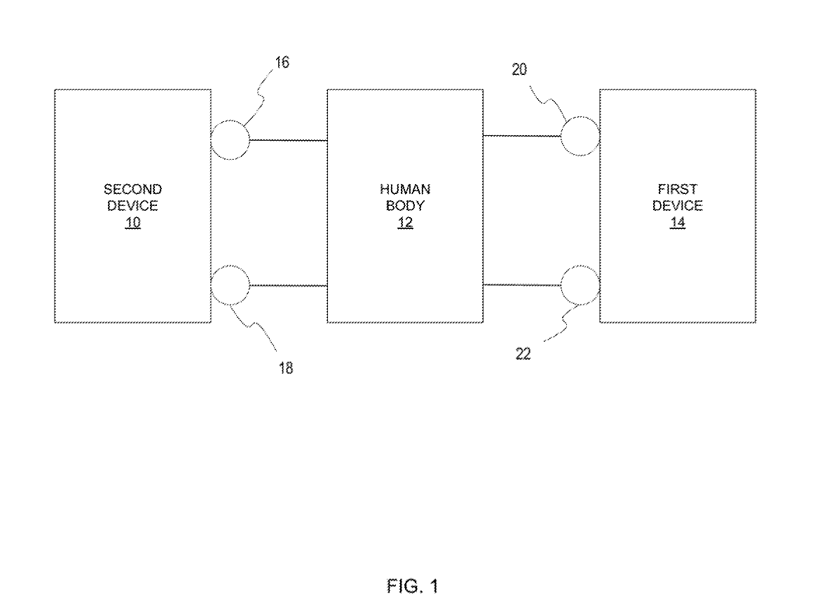

FIG. 1 illustrates a first device 14 of a personal area network with a first device 14 galvanically coupled to a second device 10 through a human body 12. The first device 14 has electrodes 20, 22 which may be placed in operative contact with the skin on the human body. The second device 10 which is located remotely from the first device 14 has electrodes 16, 18 which are in operative contact with the skin on the human body. The first device 14 and the second device 10 may communicate power and/or data therebetween. The first device 14 may be a wearable device and the second device 10 may also be a wearable device. Each of the first device 14 and the second device 10 may be ear pieces.

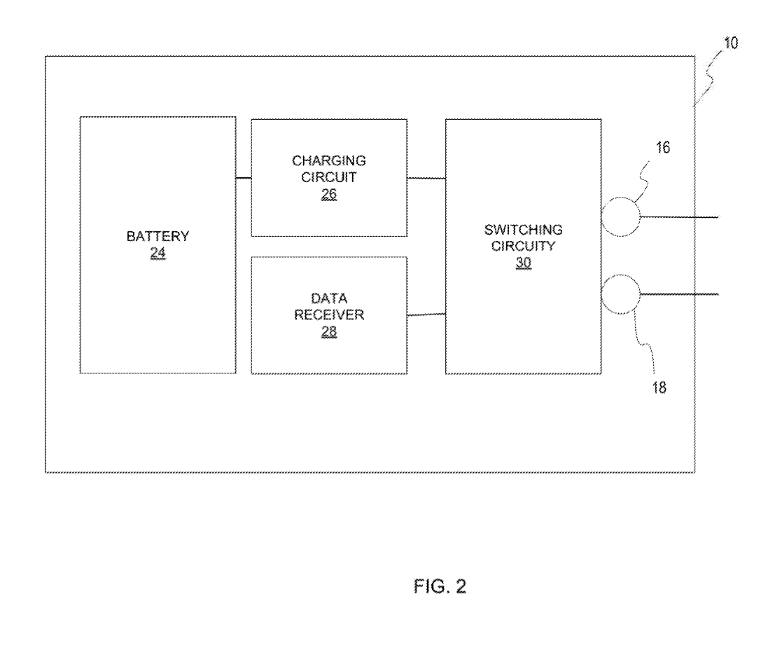

FIG. 2 illustrates a further example of the second device 10. The second device 10 may have a battery 24. In the example shown, there is switching circuitry 30 which is operatively connected to electrodes 16, 18. The switching circuitry 30 may be used to switch between galvanic coupling for data communications and galvanic coupling for power communications.

Thus, as shown in FIG. 2, the data receiver 28 may receive data communicated through the human body and the charging circuit 26 may receive a power signal communicated through the human body. The charging circuit 26 may be used to charge the battery 24.

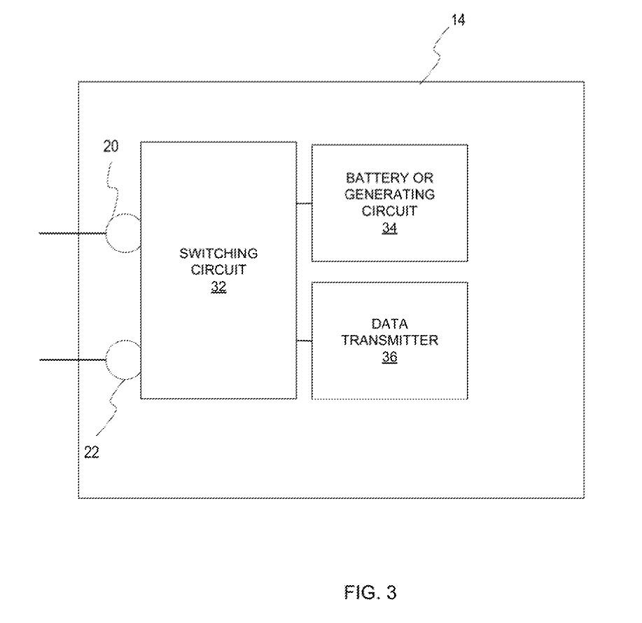

FIG. 3 illustrates a further example of a first device 14. As shown in FIG. 3, a switching circuit 32 is shown which may be used to switch between a battery of a current generating circuit 34 and a data transmitter 36. Thus, the first device 14 may be used fur communicating power over or through the human body or data or through the human body. The current generating circuit 34 may be used to generate current in any number of ways. Thus, one of the devices used may not merely use power from a battery but may generate power. For example, the device may include a piezoelectric or magneto restrictive material that may generate charge in response to various forces or motions applied by a user. This generated charge may be conveyed to one or more other devices to recharge batteries.

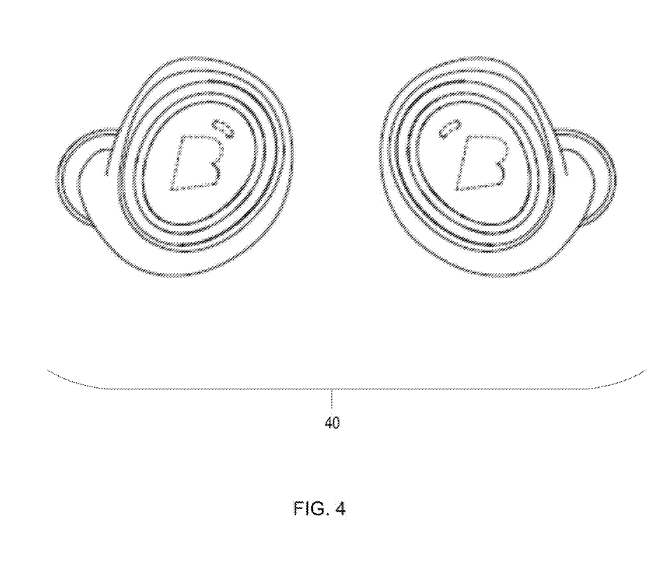

FIG. 4 illustrates a set of earpieces 40 with a left ear piece and a right ear piece. The set of earpieces may be a part of a personal area network which allow for galvanic coupling to exchange data or power. Although ear pieces are shown, it is contemplated that any number of other devices associated with a personal area network may be used. It is contemplated that any number of personal area network devices may be used this may include, wearable devices which may include without limitation, goggles, glasses, helmets, headbands, smart caps, headphones, headsets, hats, mouth guards, eyewear, headwear, harnesses, aim bands, watches, gloves, jackets, shirts, vests, pants, socks, shoes, buttons, jewelry items, necklaces, rings, clips, bands, pads, articles of clothing, and other types of devices. The wearable devices may be medical devices, fitness devices, gaming devices, industrial devices, lifestyle devices, or other types of devices. The electrodes of the devices may be placed in contact with skin of a user. It is further contemplated that any number of different devices and any number of different types of devices may be present on the personal area network. A single device may be used to communicate outgoing data or charge with one or multiple other devices. Similarly, a single device may be used to receive data or charge from one or multiple other devices.

Therefore, methods, apparatus, and systems have been shown and described. Although various example are shown and described, the present invention is not to be limited to these specific examples as numerous variations, options, and alternatives are contemplated.

What is claimed is:

1. A method comprising:
providing a first device, the first device having an electrode for placement at skin of a user;
conveying power between the electrode of the first device and an electrode of a second device, wherein both the first device and the second device are associated with a personal area network and the second device is remote from the first device;
wherein the conveying power is performed through galvanic coupling.

2. The method of claim 1 further comprising charging a battery of the second device using the power.

3. The method of claim 1 wherein the first device is a wearable device.

4. The method of claim 1 wherein the second device is a wearable device.

5. The method of claim 1 wherein the first device comprises an ear piece.

6. The method of claim 1 wherein the second device comprises an ear piece.

7. The method of claim 1 wherein the power from the first device is from a battery of the first device.

8. The method of claim 1 wherein the power from the first device is generated by the first device.

9. The method of claim 8 wherein the power from the first device is generated by the first device through converting motion associated with the user into charge.

10. The method of claim 1 further comprising conveying data between the first device and the second device through galvanic coupling.

11. The method of claim 10 wherein the electrode of the first device is used both for conveying the power and conveying the data.

12. A method comprising:
providing a first device, the first device having an electrode for placement at skin of a user;
conveying data between the electrode of the first device and an electrode of a second device, wherein both the first device and the second device are associated with a personal area network and the second device is remote from the first device;
wherein the conveying data is performed through galvanic coupling;
wherein at least one of the first device and the second device is an ear piece.

13. The method of claim 12 further comprising conveying power between the electrode of the first device and the electrode of the second device.

14. The method of claim 13 further comprising charging a battery of the second device using the power.
